(19) United States
(12) Patent Application Publication
(10) Pub. No.: US 2011/0242862 A1
(43) Pub. Date: Oct. 6, 2011

(54) SOFT START CIRCUIT FOR POWER FACTOR CORRECTION NETWORK

(75) Inventor: JERRY WESTBERG, Anderson, IN (US)

(73) Assignee: Connecticut Electric, Inc., Anderson, IN (US)

(21) Appl. No.: 12/752,324

(22) Filed: Apr. 1, 2010

(51) Int. Cl. H02M 7/04

(52) U.S. Cl. 363/89

(57) ABSTRACT

A soft start circuit for a power factor correction circuit. In one embodiment, the soft start circuit controls an input to a power factor correction pre-regulator chip to allow the output voltage to be set initially to a value lower than the desired nominal output voltage of the power factor correction circuit. Once stabilized, the input to the power factor correction pre-regulator chip is changed to increase the output voltage to the desired nominal output voltage of the power factor correction, thereby avoiding any significant overshoot of the desired nominal output.

### BACKGROUND OF THE INVENTION

It is known that where a sinusoidal alternating current power source is input into either an inductive or capacitive load, the load current is also sinusoidal but will lag or lead the input voltage by some angle. Thus, the actual power delivered to the load is a fraction of the product of the voltage and the current. The magnitude of the cosine of the angle by which the current leads or lags the voltage is referred to in the art as the power factor. It is desirable to keep the power factor as close to 1 as possible so that the input line current is in phase with the input line voltage. Correcting the phase of the current so that the voltage and current follow each other is referred to as power factor correction in the art.

A number of methods have been developed to assist in the design of a power factor correction circuit. One method of correcting the power factor of a power supply circuit is to use a continuous-mode boost regulator and a scheme to sense and control the direct current output voltage of the circuit as well as the input line current by pulse width modulation of the boost regulator. This involves the use of an inductor and transistor in series with the output of a bridge rectifier. Alternating current is fed into the bridge rectifier. The on time of the transistor is controlled to boost the half sinusoids of the input voltage from the bridge rectifier to a constant output voltage that is somewhat higher than the peak of the sinusoidal input voltage.

A number of different chips have been used in the past to perform the functions required for power factor correction. These include the Unitrode UC3854, the Motorola MC34261 and 34262, the Microlinear ML4821, the Linear Technology 1248, the Toko 83854, and the Unitrode 3854. Additionally, the Texas Instruments UCC2817, 2818, 3817, and 3818 chips are also used as power factor pre-regulators.

In the recreational vehicle (RV) industry, a need has arisen for power supplies with larger available power. Traditionally, the power supply for RVs has been limited to about 65 amps using conventional power converters. However, more recently, the demand for power has increased and has necessitated the use of power factor correction (PFC) to obtain the power needed. Moreover, it is important in the RV industry to provide products that are inexpensive to manufacture.

Traditional RV power supplies have been manufactured using components having 250 volt ratings. Based on these components the addition of a PFC circuit to a RV power supply while maintaining a low cost, requires that the output of the PFC circuit be limited to approximately 200 volts to avoid damaging the components rated at 250 volts.

When a power converter in an RV is started in a no load condition with a PFC circuit, there is a possibility that the voltage will overshoot the nominal 200 volt setting and potentially damage the components in the power supply due to the fact that there is only a 50 volt margin on these components. Soft start features have been provided with the power factor pre-regulators such as the UCC2818. A capacitor may be attached to the soft start pin of the chip to control the duty cycle of the pulse-width modulator so that it increases slowly. However, this feature is not sufficient to prevent overshoot in a situation where the desired nominal voltage is approximately 200 volts and the device ratings are 250 volts.

Therefore, there is a need for a soft start circuit that can be added to a power factor pre-regulator chip to more effectively control the overshooting to avoid damage to system components.

### BRIEF SUMMARY OF THE INVENTION

The present invention provides a circuit that will prevent the output of a PFC circuit from exceeding the desired voltage. In one embodiment of the invention, the circuitry used to set the desired voltage output generated by a PFC chip and boost regulator is arranged such that the voltage output is first taken to a level lower than the desired output and once steady state is obtained, increasing the voltage output to the desired nominal voltage output.

### BRIEF DESCRIPTION OF THE SEVERAL VIEWS OF THE DRAWINGS

FIG. 1 is a simplified schematic diagram of a power factor correction circuit in accordance with an embodiment of the invention.

FIG. 2 is a schematic diagram showing a circuit that may be used to control the modulation of the voltage output of a power factor correction circuit in accordance with an embodiment of the invention.

### DETAILED DESCRIPTION OF THE DRAWINGS

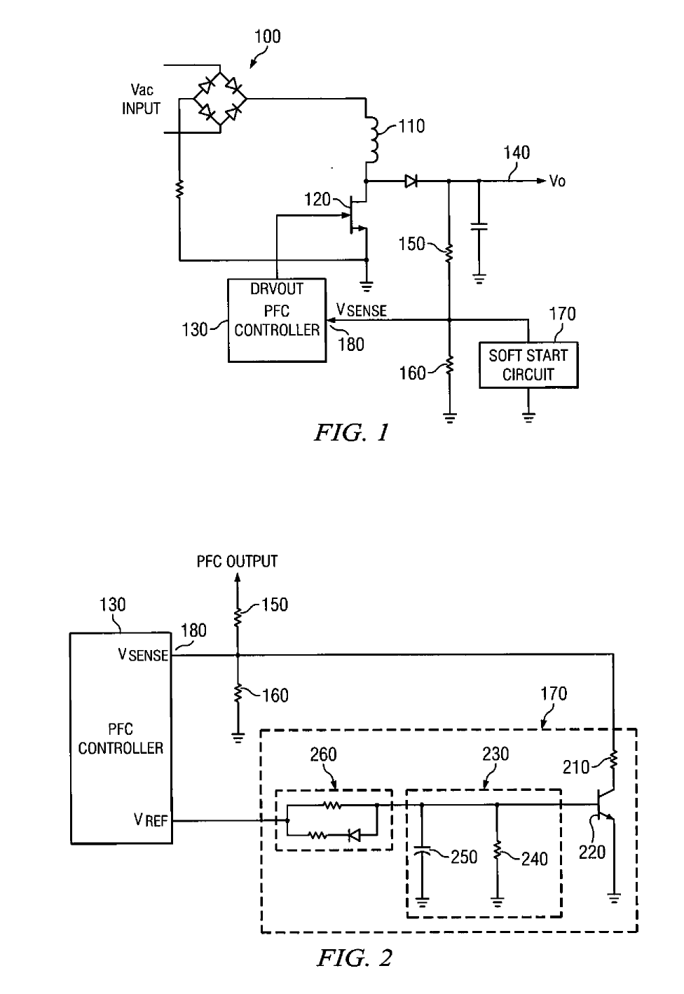

Referring now to FIG. 1, a simplified schematic diagram of a power factor correction circuit in accordance with an embodiment of the invention is illustrated. FIG. 1 represents the use of power factor correction to take an alternating voltage input to give a direct voltage output that is somewhat higher than the peak of the sinusoidal input from the source. In one embodiment, the desired output is 200 volts DC, and the input voltage is approximately 120 volts AC.

The AC voltage is input into a bridge rectifier 100 and the output of the bridge rectifier is connected in series with an inductor 110 and a field effect transistor (FET) 120. The FET 120 is used to control the DC output and is driven by the PFC controller 130. The output Vₒ 140 of the power factor correction circuit is determined in part by the value of resistors 150 and 160. In one embodiment, to obtain the desired output of approximately 200 volts, resistor 150 can be a resistor of 499 k ohms and resistor 160 can be a value of 22.3 k ohms. Additionally, the soft start circuit 170 will control the voltage applied to the VSENSE pin 180 of the PFC controller chip to thereby control the output voltage Vₒ 140. The soft start circuit 170 is effectively a resistor in parallel with resistor 160. The effective resistance of the soft start circuit 170 is initially infinite but after a period of time, the resistance is decreased to a predetermined value to give the desired nominal output at Vₒ. In one embodiment, a resistance value of 150 k ohms will give the desired output of approximately 200V. By decreasing the resistance value of soft start circuit 170 over time, overshoot of the desired output voltage is avoided.

Referring now to FIG. 2 a schematic diagram showing a circuit that may be used to control the level of the voltage output of a power factor correction circuit in accordance with an embodiment of the invention is illustrated. The soft start circuit 170 includes a resistor 210 in series with the collector of an NPN transistor 220. The emitter of the transistor 220 is grounded. The base of the transistor 220 is connected through a resistor/capacitor timing circuit 230 that allows the transistor 220 to be turned on after a delay. In one embodiment of the invention, the resistor 240 has a value of 25.5 k ohms and the capacitor 250 has a value of 100μ farads. Upon startup of the circuit, the capacitor 250 is charged. Once charged, the transistor 220 is turned on allowing current to flow through resistor 210 placing resistor 210 in parallel with resistor 160 and decreasing the value of the resistance on the lower end of the voltage divider resulting in a lower voltage being applied to the VSENSE pin of PFC controller. This causes the PFC output to increase to the desired 200 volts. However, because the initial voltage to which the PFC controller raised the output was set at 175 volts using the value of resistors 150, 160, any overshoot of the desired 200 volt output is minimal and component damage is avoided. The resistor diode circuit 260 drains the capacitor whenever the PFC circuit is turned off so that when the circuit is turned back on again the capacitor 250 starts at zero charge.

I claim:

1. A circuit for controlling the voltage output of a power factor correction circuit in a power supply for a recreational vehicle comprising:
a rectifier for converting alternating current to direct current;
an inductor connected in series with the rectifier;
a boost regulator connected in series with said inductor;
a power factor pre-regulator chip for driving said boost regulator;
a voltage divider connected to an output of said power factor correction circuit for providing an input voltage to said power factor pre-regulator chip for setting a nominal voltage output for said power factor correction circuit wherein said voltage divider is arranged such that said input voltage has a higher value upon a startup of said power supply and is reduced to a lower value after said output reaches a steady state condition such that said output is set to said nominal voltage value while minimizing overshooting of said nominal voltage value.

2. The circuit of claim 1 wherein said voltage divider comprises a first resistor connected to said output of said power factor correction circuit and a second resistor connected in series with said first resistor and a soft start circuit connected in parallel with said second resistor wherein said soft start circuit is configured such that a voltage drop across said second resistor is said higher value upon said startup and is applied as said input voltage to said power factor pre-regulator chip.

3. The circuit of claim 2 wherein no current is allowed to flow through said soft start until said output reaches a steady state below said nominal voltage value.

4. The circuit of claim 3 wherein said soft start circuit comprises a transistor connected in series with a resistor wherein said transistor is turned off upon said startup and after said output reaches said steady state, said transistor is turned on to allow current to flow through said resistor and said transistor to a ground such that said output is set to said nominal voltage value.

5. The circuit of claim 4 wherein said transistor is turned on using a timing circuit connected to a base of said transistor wherein said timing circuit is activated when said power factor correction circuit is turned on.

6. The circuit of claim 5 wherein said timing circuit comprises a third resistor connected in parallel with a capacitor wherein a first end of said capacitor and a first end of said third resistor are connected to said base of said transistor and wherein a second end of said capacitor and a second end of said third resistor are connected to said ground.

7. The circuit of claim 6 wherein said base of said transistor is connected to a reference voltage output of said power factor pre-regulator chip, wherein said values of said third resistor and said capacitor are set to allow said output to reach said steady state before said transistor is turned on.

8. The circuit of claim 7 wherein said soft start circuit further comprises a resistor diode circuit connected between said reference voltage output and said base of said transistor for draining said capacitor when said power factor pre-regulator chip is turned off.

9. The circuit of claim 8 wherein said resistor diode circuit comprises a diode connected on a first end to said base of said transistor and to a first end of a fourth resistor and connected on a second end to a first end of said fifth resistor, wherein a second end of said fifth resistor is connected to said reference voltage output and to a second end of said fourth resistor.
